(19) United States
(12) Patent Application Publication
(10) Pub. No.: US 2007/0150918 A1
(43) Pub. Date: Jun. 28, 2007

(54) Methods, devices, and computer program products for providing parental control over access to media content using a mobile terminal

(75) Inventors: Paul Carpenter, Raleigh, NC (US); Allen East, Cary, NC (US)

Correspondence Address: MYERS BIGEL SIBLEY & SAJOVEC, PO BOX 37428, RALEIGH, NC, 27627, US

(73) Assignee: Sony Ericsson Mobile Communications AB

(21) Appl. No.: 11/316,435

(22) Filed: Dec. 22, 2005

(51) Int. Cl. H04N 7/16

(52) U.S. Cl. 725/25

(57) ABSTRACT

Methods for providing parental control over access to media content includes controlling presentation of the media content responsive to receiving a parental control request from a mobile terminal over a wide-area network connection. Related devices and computer program products are also discussed.

### FIELD OF THE INVENTION

The present invention relates to accessing media content over communications networks, and, more particularly, to methods and devices for controlling access to media content over communications networks.

### BACKGROUND OF THE INVENTION

Communications networks are widely used for nationwide and worldwide communication of voice, multimedia, and/or other data. As used herein, communications networks include public communications networks, such as the public switched telephone network (PSTN), terrestrial and/or satellite cellular networks, cable and/or satellite television networks, and/or the Internet.

In communications networks, a signal may be broadcast throughout the entire network and/or transmitted to one or more portions thereof. Devices connected to the network that are authorized to receive the signal may include a decoder capability, thereby allowing end users to access the communication signal. Some examples of signals broadcast over communications networks include broadcast television, broadcast AM/FM radio, cable and satellite television, satellite radio, Internet radio, and/or other Internet protocol broadcasts. In addition, other audio/video content, such as interactive games, music, and/or movies, may also be transmitted over communications networks. As used herein, information that may be broadcast and/or otherwise transmitted over a communications network is referred to as “media content”.

For example, where the broadcast signal is a cable television signal, a cable television subscriber may have a device, such as a cable box or other customer premises media controller, that may be configured to present the media content provided by the cable television signal via a television and/or monitor for viewing by the subscriber. The media content may include talk shows, sports broadcasts, movies, news, traffic reports, commercials, and/or other time-scheduled programming. A cable TV subscriber may thereby receive some media content that may be inappropriate for children and/or minors, and as such, may wish to prevent a child/minor from viewing such media content.

Accordingly, it is known to provide a lockout feature on a cable box or other customer premises media controller that is configured to receive the media content at the customer premises. For example, the lockout feature may enable a user to block access to options, such as certain channels, pay-per-view purchases, and/or movie channel purchases. More specifically, the customer premises media controller may include a menu option accessible to a user, allowing the user to enter a security code to activate the lockout feature to thereby disable presentation of specified media content. After activation of the security feature, the security code may have to be re-entered before a user is allowed to access the specified media content. Thus, a parent may prevent a child from viewing and/or otherwise accessing particular media content that the parent may deem inappropriate for the child. However, in doing so, the parent may also prevent the child from accessing some content that may be appropriate and/or desirable for the child. For example, although a parent may “lock” a particular channel that presents adult content in the evenings, the same channel may also present child-friendly content in the mornings/afternoons. Accordingly, child dissatisfaction may arise in situations where the parent may not be at home to disable the lockout feature.

### SUMMARY OF THE INVENTION

According to some embodiments of the present invention, a method for providing parental control over access to media content includes controlling presentation of the media content responsive to receiving a parental control request from a mobile terminal over a wide-area network connection.

In some embodiments, available media content may be received at a customer premises media controller, and the parental control request may be received at the customer premises media controller over the wide-area network. As such, presentation of the available media content may be controlled at the customer premises media controller responsive to the received parental control request.

In other embodiments, the parental control request may include permissions information for previously prohibited media content. Based on the permissions information, the previously prohibited media content may be presented via a television/monitor coupled to the customer premises media controller. In addition, a local request for the previously prohibited media content may be received at the customer premises media controller, and a request for authorization to grant the local request may be transmitted from the customer premises media controller to the mobile terminal over the wide-area network connection.

In some embodiments, the parental control request may include permissions information for previously allowable media content. Based on the permissions information, presentation of the previously allowable media content on a television/monitor coupled to the customer premises media controller may be limited. For example, presentation of the previously allowable media content may be prevented by preventing reception of the previously allowable media content at the customer premises media controller.

In other embodiments, the parental control request may be received at the customer premises media controller via a local network hub coupled thereto. In addition, the parental control request may be received at the customer premises media controller from a remotely-located mobile terminal.

In some embodiments, the parental control request may be received at a service provider media controller over the wide-area network connection. A customer premises media controller associated with the received parental control request may be identified by the service provider media controller. As such, presentation of the media content may be controlled at the service provider media controller responsive to the received parental control request. For example, presentation of the media content may be controlled at the service provider media controller by providing the mobile terminal with access to the identified customer premises media controller over the wide-area network.

In other embodiments, presentation of the media content may be controlled at the service provider media controller by transmitting a control signal from the service provider media controller to the customer premises media controller responsive to the received parental control request.

In some embodiments, the parental control request may include permissions information for previously prohibited media content. Presentation of the media content may be controlled at the service provider media controller by transmitting the previously prohibited media content to the customer premises media controller based on the permissions information.

In other embodiments, the parental control request may include permissions information for previously allowable media content. Presentation of the media content may be controlled at the service provider media controller by preventing transmission of the previously allowable media content to the customer premises media controller based on the permissions information.

In some embodiments, a media content preview request may be received from the mobile terminal over the wide-area network connection. Preview data associated with the media content may be transmitted to the mobile terminal over the wide-area network connection responsive to the received preview request. The parental control request may be received from the mobile terminal responsive to the transmitted preview data.

In other embodiments, the media content may include time-scheduled broadcast media content, interactive game content, and/or video-on-demand content.

In some embodiments, the received parental control request may be authenticated, and presentation of the media content may be controlled responsive to authentication of the parental control request.

In other embodiments, a passcode may be requested from the mobile terminal responsive to the received parental control request. The passcode may be received from the mobile terminal over the wide-area network connection. The received passcode may be compared to a predetermined authorization code, and presentation of the media content may be controlled when the received passcode corresponds to the predetermined authorization code.

In some embodiments, current parental control information may be transmitted to the mobile terminal over the wide-area network connection responsive to the received parental control request, and updated parental control information may be received from the mobile terminal over the wide-area network connection. Presentation of the media content may be controlled based on the updated parental control information.

In other embodiments, the parental control request may be transmitted over the wide-area network connection. The parental control request may identify particular media content, and may include permissions information associated with the particular media content. Presentation of the particular media content may be controlled based on the permissions information.

According to further embodiments of the present invention, a method of operating a mobile terminal to provide parental control over access to media content includes establishing a wide-area network connection with a media controller configured to control presentation of the media content. A parental control request is transmitted from the mobile terminal to the media controller over the wide-area network connection. The parental control request may be configured to control presentation of the media content by the media controller.

In some embodiments, current parental control information may be received from the media controller over the wide-area network connection responsive to transmitting the parental control request thereto. Updated parental control information may be transmitted to the media controller over the wide-area network connection. The updated parental control information may include an authorization to present previously prohibited media content and/or to limit presentation of previously allowable media content to the media controller over the wide-area network connection.

In some embodiments, the parental control request may be transmitted over the wide-area network connection to a customer premises media controller coupled to a television/monitor configured to present the media content. In other embodiments, the parental control request may be transmitted to a service provider media controller over the wide-area network connection.

In further embodiments, a media content preview request may be transmitted to the media controller over the wide-area network connection, and preview data associated with the media content may be received from the media controller over the wide-area network connection responsive to transmitting the media content preview request. The parental control request may be transmitted responsive to the received preview data.

According to still further embodiments of the present invention, a media controller includes a receiver and a processor coupled to the receiver. The receiver is configured to receive a parental control request from a mobile terminal over a wide-area network connection. The processor is configured to control presentation of the media content responsive to the received parental control request.

In some embodiments, the media controller may include a media content receiver. The media content receiver may be configured to receive media content from a media service provider. The processor may be configured to present previously prohibited media content and/or limit presentation of previously allowable media content via a television/monitor coupled thereto based on the parental control request. For example, the processor may be configured to control the media content receiver to prevent reception of the previously allowable media content from the media service provider based on the parental control request.

In other embodiments, the processor may be configured to identify a customer premises media controller associated with the received parental control request. As such, the processor may be configured to control presentation of the media content by the identified customer premises controller. For example, the processor may be configured to transmit a control signal to the customer premises media controller to control presentation of the media content thereby. In addition, the processor may be configured to transmit previously prohibited media content and/or prevent transmission of previously allowable media content to the customer premises media controller based on the parental control request.

In some embodiments, the receiver may be configured to receive a media content preview request from the mobile terminal. The media controller may further include a transmitter that may be configured to transmit preview data associated with the media content to the mobile terminal over the wide-area network connection.

### BRIEF DESCRIPTION OF THE DRAWINGS

FIG. 1 is a block diagram illustrating a system for providing parental control over access to media content according to some embodiments of the present invention.

FIG. 2 is a block diagram illustrating a system for providing parental control over access to media content according to further embodiments of the present invention.

FIGS. 3A and 3B are block diagrams illustrating mobile terminals according to some embodiments of the present invention.

FIG. 4 is a block diagram illustrating a media controller according to some embodiments of the present invention.

FIGS. 5 through 10 are flowcharts illustrating methods for providing parental control over access to media content according to some embodiments of the present invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present specification and/or the relevant art, and will not be interpreted in an idealized or overly formal sense unless expressly so defined herein.

As used herein, a “mobile terminal” may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer, calendar and/or a global positioning system (GPS) receiver; and/or conventional laptop and/or palmtop computers or other appliances that include a radio frequency transceiver. Mobile terminals may be portable, transportable, installed in a vehicle (aeronautical, maritime, or land-based), or situated and/or configured to operate locally and/or in a distributed fashion at any other location(s).

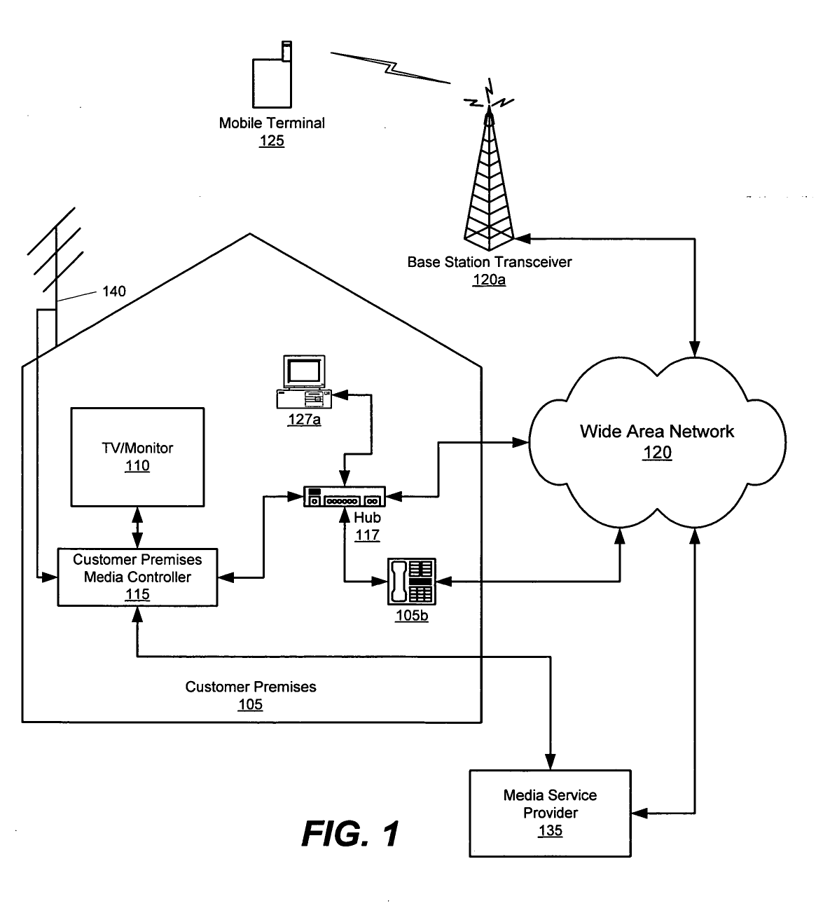

Embodiments of the present invention will now be described with reference to FIGS. 1-10. Some embodiments of the present invention arise from a realization that it may be convenient for a parent and/or other guardian of a child/dependent to be able to change and/or otherwise modify parental control information for a cable box or other customer premises media controller from outside the home. For example, when a parent is away from home, a child who is at home with a babysitter may wish to access media content that has been previously prohibited by the parent, and, in some instances, the parent may wish to enable presentation of the previously prohibited content without giving the code for the media controller to the child and/or babysitter. Accordingly, some embodiments of the present invention provide methods, devices, and computer program products configured to control presentation of media content responsive to receiving a parental control request from a mobile terminal over a wide area network connection.

As used herein, a “parental control request” may include a request to access and/or alter current parameters associated with the presentation and/or restriction of media content at a media controller based on a suitability of the media content for a child and/or other dependent. The parental control request may also include identification information for the device and/or user submitting the parental control request, for example, for purposes of authentication. The media content may include time-scheduled broadcast media content, such as television shows, interactive game content, such as video and/or other computer games, and/or video-on-demand content, such as pay-per-view content. Also, as used herein, “available media content” refers to media content that is currently (or at a scheduled time) accessible to the media controller, while “purchasable media content” refers to media content that may be accessed by the media controller responsive to payment of a fee.

FIG. 1 is a block diagram illustrating systems for providing parental control over access to media content according to some embodiments of the present invention. Referring now to FIG. 1, a mobile terminal 125 may be configured to establish a wide-area network connection with a customer premises media controller 115 that is configured to control presentation of audio and/or video media content at a customer premises 105 via a device, such as a television/monitor 110. More particularly, the mobile terminal 125 may establish a connection with the customer premises media controller 115 over a wide area network (WAN) 120 via a base station transceiver 120a. The mobile terminal 125 may be a remotely-located mobile terminal, such as a cellular telephone belonging to a parent and/or other individual associated with the customer premises 105 who is currently away from the customer premises 105. The customer premises media controller 115 may be coupled to the wide area network 120 directly and/or via a local network hub 117. The local network hub 117 may also be coupled to additional electronic equipment at the customer premises 105, such as a personal computer 127a and/or a telephone 105b.

The wide area network (WAN) 120 is a telecommunications network that spans a relatively large geographic area. As used herein, a WAN distinguishes a broader telecommunications structure from a local area network (LAN). As such, a WAN excludes Bluetooth, infrared (IR), and/or other short-range network connections between devices. Typically, a WAN includes two or more LANs. Devices connected to a WAN are often connected through public and/or private networks, leased lines, and/or satellites. More particularly, WANs may be connected using the public-switched telephone network (PSTN), ISDN (integrated services digital network), frame relay, ATM (a synchronous transfer mode), and/or other high speed services. In some embodiments, the WAN 120 may be coupled to and/or may include an IP Multimedia Subsystem (IMS) network. IMS is a standard that has been developed to provide for control and integration of multimedia services in a packet-switched network. In particular, the IMS architecture defines a set of logical functions that use a signaling protocol, known as session initiation protocol (SIP), to setup, maintain, and terminate packet-switched voice and data. More generally, an IMS network may provide a standardized way to connect IP devices and networks.

Still referring to FIG. 1, the customer premises media controller 115 may be configured to receive media content from a media service provider 135. The media service provider 135 may be a local TV station, a cable company, and/or a satellite television service provider. The customer premises media controller 115 may receive the media content broadcast from the service provider 135 via an antenna 140, and/or via a cable and/or a satellite connection to the media service provider 135.

The customer premises media controller 115 may also be configured to receive a parental control request transmitted from the mobile terminal 125 over the wide area network 120. As described above, the parental control request may include information related to accessing and/or altering current parameters associated with the presentation of media content based on a suitability of the media content for a child. Accordingly, the customer premises media controller 115 may be configured to control presentation of the media content on the TV/monitor 110 responsive to receiving the parental control request from the mobile terminal 125. For example, the customer premises media controller 115 may have its own Internet Protocol (IP) address, and the mobile terminal 125 may access the customer premises media controller 115 and transmit the parental control request thereto by establishing an Internet connection with the customer premises media controller 115 over the wide area network 120 based on the IP address. In addition and/or alternatively, the customer premises media controller 115 may include its own wireless transceiver, such as a PLMN transceiver, and the mobile terminal 125 may establish a connection with the customer premises media controller 115 via the wireless transceiver over the wide area network 120. Also, as the customer premises media controller 115 may be coupled to the wide area network 120 via the local network hub 117, the connection between the mobile terminal 125 and the customer premises media controller 115 may be established through the local network hub 117.

In addition, the customer premises media controller 115 may be configured to transmit current parental control information to the mobile terminal 125 over the wide area network 120 responsive to receiving the parental control request. The parental control information may include permissions information associated with the presentation of specific media content. The customer premises media controller 115 may also receive updated parental control information from the mobile terminal 125 over the wide area network 120, and may control presentation of the media content on the TV/monitor 110 based on the updated parental control information.

For example, the parental control request and/or the updated parental control information may specify updated permissions information for media content that was previously prohibited by the user of the mobile terminal 125. More particularly, a parent and/or other guardian using the mobile terminal 125 may wish to change the permissions information associated with previously prohibited media content, such that a child and/or other dependent at the customer premises 105 may view the previously prohibited media content. As such, responsive to receiving the updated permissions information, the customer premises media controller 115 may be configured to present the previously prohibited media content via the television/monitor 110 at the customer premises 105.

Similarly, the parental control request and/or the updated parental control information may specify updated permissions information for previously allowable media content, and the customer premises media controller 115 may be configured to prevent presentation of the previously allowable media content on the TV/monitor 110 based on the updated permissions information. For instance, the customer premises media 115 may prevent presentation of the previously allowable media content by refusing to receive the particular media content from the media service provider 135. As such, a parent/guardian who is away from the customer premises 105 may remotely enable or prevent presentation of particular media content at the customer premises 105 by transmitting a request via the mobile terminal 125.

In addition, a user of the mobile terminal 125 may be alerted when a child and/or other dependent on the customer premises 105 is attempting to access prohibited media content via the customer premises media controller 115. More specifically, when a local request for the previously prohibited media content is received at the customer premises media controller 115 (for example, from a child at the customer premises 105), the customer premises media controller 115 may be configured to transmit a request for authorization to grant the local request to the mobile terminal 125 over the wide area network 120. The parent/guardian using the mobile terminal 125 may then grant or deny the request by transmitting the appropriate response.

Also, the customer premises media controller 115 may be configured to authenticate the mobile terminal 125 and/or user thereof responsive to receiving the parental control request. For example, the customer premises media controller 115 may authenticate the mobile terminal based on public/private key cryptography and/or other authentication as are well known in the art. The customer premises media controller 115 may control the presentation of the media content responsive to successful authentication of the mobile terminal 125. Furthermore, the customer premises media controller 115 may request a passcode from the mobile terminal responsive to receiving the parental control request. The customer premises media controller 115 may receive the passcode from the mobile terminal over the wide area network 120, and may compare the received passcode to a predetermined authorization code. As such, presentation of the media content on the TV/monitor 110 may be enabled and/or disabled when the received passcode from the mobile terminal 125 corresponds to a predetermined authorization code. For example, the predetermined authorization code may be a user-defined code and/or PIN (personal identification number) chosen by the parent/guardian.

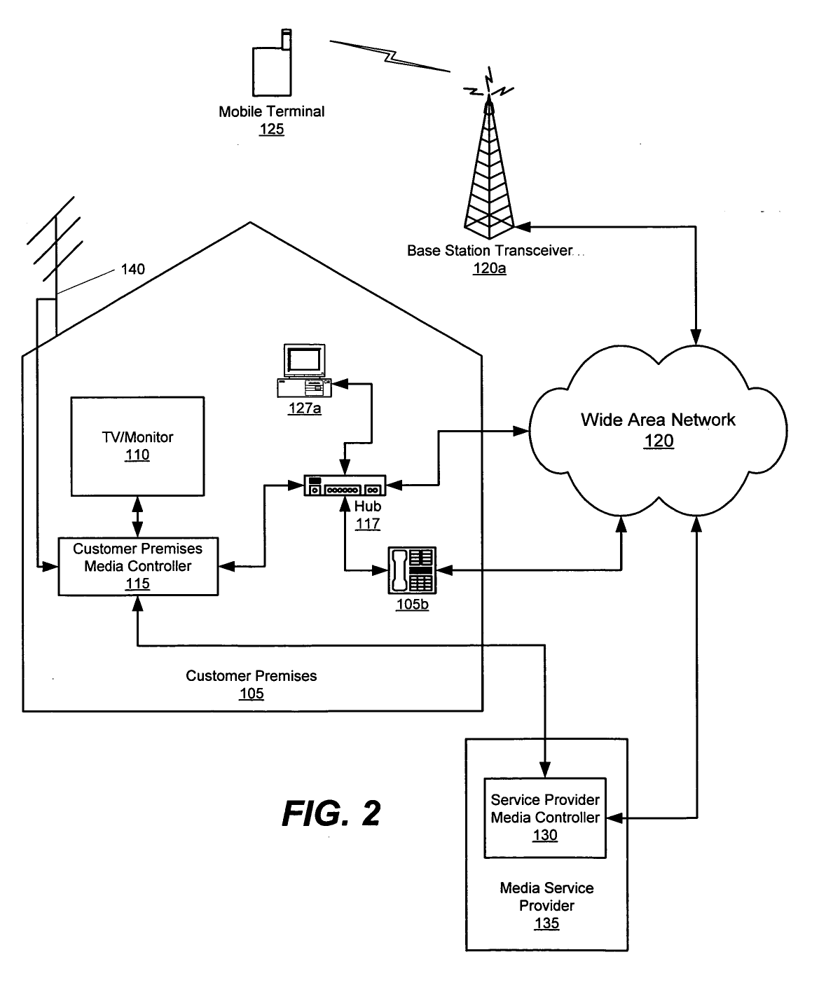

FIG. 2 is a block diagram illustrating a system for providing parental control over access to media content according to further embodiments of the present invention. Referring now to FIG. 2, the media service provider 135 includes a service provider media controller 130 coupled to the customer premises media controller 115. The service provider media controller 130 may be configured to transmit the media content and/or other control signals to the customer premises media controller 115. As such, the service provider media controller 130 may be configured to control presentation of the media content on the TV/monitor 110 at the customer premises 105 responsive to receiving a parental control request from the mobile terminal 125.

More particularly, the service provider media controller 130 may be configured to receive the parental control request transmitted from the mobile terminal 125 over the wide area network 120. For example, the service provider media controller 130 may be associated with an IP address provided by the media service provider 135, and the mobile terminal 125 may thereby access the service provider media controller 130 by establishing a connection thereto over the wide area network 120. As the service provider media controller 130 may provide media content to a plurality of customers of the media service provider 135, the service provider media controller 130 may be configured to identify a particular customer premises media controller 115 that is associated with a received parental control request from the mobile terminal 125. For example, the service provider media controller 130 may be configured to identify a customer account associated with the received parental control request based on identification information contained in the parental control request. The customer account may be identified from a customer database maintained by the media service provider 135, which may be accessible to the service provider media controller 130. The service provider media controller 130 may determine a customer premises media controller 115 associated with the identified account, and may thereby provide the mobile terminal 125 with remote access to the customer premises media controller 115.

For example, in some embodiments, the service provider media controller 130 may merely act as a router to provide the mobile terminal 125 with a connection to the identified customer premises media controller 115 over the wide area network 120. In other embodiments, the service provider media controller 130 may be configured to transmit a control signal to the customer premises media controller 115 responsive to receiving the parental control request from the mobile terminal 125. The customer premises media controller 115 may be configured to enable or limit presentation of the media content responsive to receiving the control signal from the service provider media controller 130. In other words, the service provider media controller 130 and the customer premises media controller 115 may have a master/slave relationship, where the service provider media controller 130 may have unidirectional control over the customer premises media controller 115.

In still other embodiments, the service provider media controller 130 may be configured to prevent transmission of the media content to the customer premises media controller 115 altogether based on the parental control request received from the mobile terminal 125. More particularly, the service provider media controller 130 may be configured to prevent transmission of media content that is indicated as prohibited, based on the updated permissions information. In other words, the service provider media controller 130 may be configured to transmit media content to the customer premises media controller 115 only when the media content is indicated as allowable by the updated permissions information received from the mobile terminal 125.

Still referring to FIG. 2, the parent/guardian may also preview the media content using the mobile terminal 125 to determine whether the media content is appropriate for a child/dependent. More particularly, the service provider media controller 130 may be configured to receive a media content preview request transmitted from the mobile terminal 125 over the wide area network 120. The service provider media controller 130 may then transmit preview data associated with particular media content, as specified in the media content preview request, to the mobile terminal 125 over the wide area network 120. For example, a child and/or other dependent under the care of a babysitter may call a parent and/or other guardian, and may ask permission to view a particular movie that the parent had previously blocked access to using the customer premises media controller 115. The parent/guardian may then view a preview of the media content on the mobile terminal 125, and decide whether the specified movie is appropriate for the child/dependent at the customer premises 105. Based on this determination, the parent/guardian may either grant or deny access to the specified movie by transmitting the parental control request to the service provider media controller terminal 130 over the wide area network 120.

Although FIGS. 1 and 2 illustrate exemplary systems for providing parental control over access to media content, it will be understood that the present invention is not limited to such configurations, but is intended to encompass any configuration capable of carrying out the operations described herein. For example, although the customer premises media controller 115 and the TV/monitor 110 are illustrated as separate elements, the functionality of the customer premises media controller 115 may be integrated into the TV/monitor 110, for example, as in an Internet protocol television (IPTV). In addition, although described above primarily with respect to packet-switched connections over the WAN 120, the mobile terminal 125 may establish a wide area network connection with the customer premises media controller 115 and/or the service provider media controller 130 via a circuit-switched connection. Moreover, although a direct connection is shown between the customer premises media controller 115 and the service provider media controller 130, the customer premises media controller 115 may be connected to the service provider media controller 130 through a local area network (LAN) and/or a wide area network (WAN), and/or other public and/or private network.

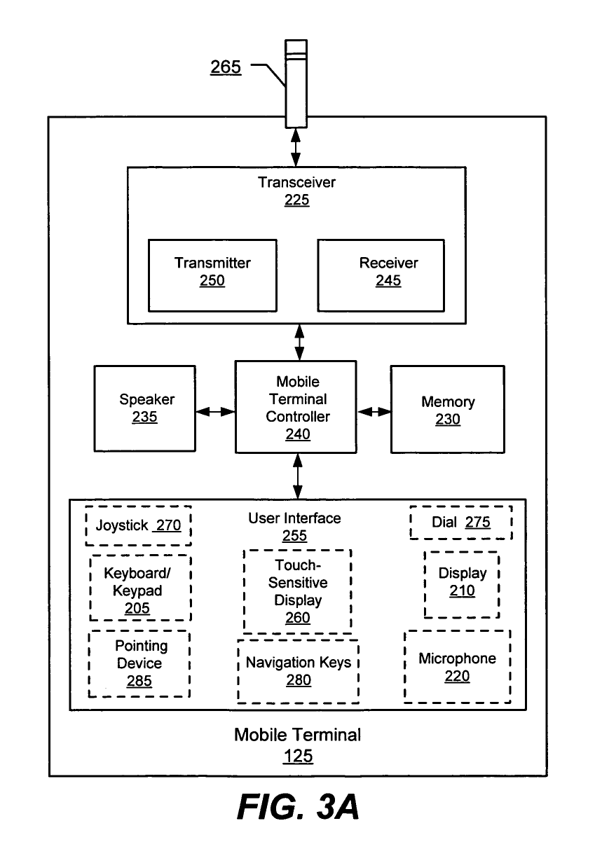

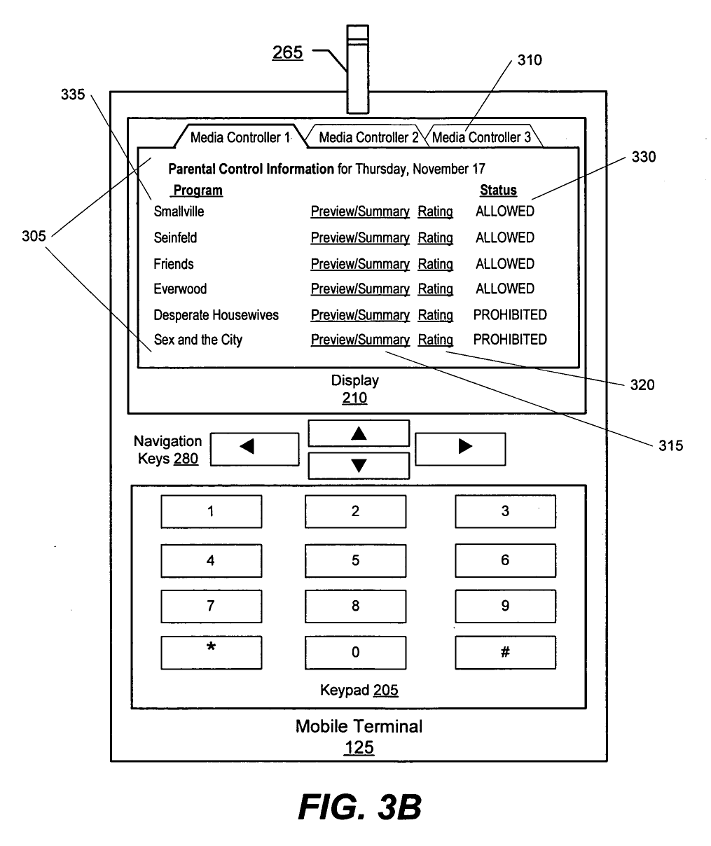

FIGS. 3A and 3B are block diagrams of mobile terminals configured to provide parental control over access to media content according to some embodiments of the present invention. As shown in FIG. 3A, a mobile terminal 125 includes a transceiver 225, an antenna 265, a controller 240, a memory 230, a speaker 235 and a user interface 255. Depending on the functionalities offered by the mobile terminal 125, the user interface 255 may include a microphone 220, a display 210 (such as a liquid crystal display), a joystick 270, a keypad 205, a touch sensitive display 260, a dial 275, navigation/directional keys 280, and/or a pointing device 285 (such as a mouse, track ball, touch pad, etc.). However, additional and/or fewer elements of the user interface 255 may actually be provided. For example, the touch sensitive display 260 may be provided in a personal digital assistant (PDA) that does not include a display 210, a keypad 205, and/or a pointing device 285.

The transceiver 225 as shown includes a transmitter 250 and a receiver 245. The transceiver 225 of the mobile terminal 125 may be configured to establish a wide area network connection with a media controller configured to control presentation of media content at a customer premises, such as the customer premises media controller 115 of FIG. 1 and/or the service provider media controller 130 of FIG. 2. The transceiver 225 may include a public land mobile network (PLMN) transceiver and/or a wireless modem. As such, the mobile terminal 125 may use the PLMN transceiver and/or the wireless modem to establish a wide area network connection with the media controller via a base station of a wide area network, such as a PLMN. The wide-area network connection may be a packet-switched connection, such as that provided by the Enhanced Data GSM Environment (EDGE) standard, the General Packet Radio Service (GPRS) standard, and/or the Universal Mobile Telecommunications System (UMTS) standard. In addition, the mobile terminal 125 may use the transceiver 225 to establish the wide area network connection with the media controller through the base station of a WAN using a circuit-switched connection. The WAN may represent a global network, such as the Internet, or other public and/or private wide area network.

Still referring to FIG. 3A, the controller 240 is coupled to the transceiver 225, the memory 230, the speaker 235, and the user interface 255. The controller 240 may be, for example, a commercially available or custom microprocessor that is configured to coordinate and manage operations of the transceiver 225, the memory 230, the speaker 235, and/or the user interface 255. As such, the controller may be configured to transmit a parental control request from the mobile terminal 125 to the media controller via the transceiver 225, to thereby control presentation of the media content.

More specifically, the transceiver 225 may be configured to receive current parental control information from the media controller over the wide area network connection responsive to transmitting the parental control request. The controller 240 may then transmit updated parental control information to the media controller over the wide area network connection via the transceiver 225. The media controller may be configured to control presentation of the media content based on the updated parental control information. For example, the controller 240 may be configured to transmit updated parental control information including an authorization to present previously prohibited media content and/or to prevent presentation of previously allowable media content to the media controller over the wide area network connection. In addition, the controller 240 may be configured to transmit a media content preview request to the media controller over the wide area network connection, and may be configured to receive preview data associated with the specified media content from the media controller via the transceiver 225. As such, a parent/guardian using the mobile terminal 125 may view the preview data to determine whether the specified media content is appropriate for his child/dependent.

The location of the media controller may be transparent to the mobile terminal 125. As such, the mobile terminal 125 may be configured to transmit the parental control request to one or more media controllers at a single physical location, and/or to media controllers at different physical locations, depending on the configuration of the parental control network. More specifically, where appropriate, the mobile terminal 125 may be configured to transmit the parental control request over the wide area network to one or more customer premises media controllers, such as the customer premises media controller 115 of FIG. 1, coupled to a TV/monitor that is configured to present the media content. In addition, the mobile terminal 125 may be configured to transmit the parental control request to a service provider media controller, such as the service provider media controller 130 of FIG. 2, over the wide area network connection, where the system is so configured.

It is to be understood that, in some embodiments, the mobile terminal 125 may not belong to the parent/guardian. For example, the mobile terminal 125 may be owned by or otherwise associated with the media service provider, and may be offered as a courtesy to current customers at a convenient location, such as a mall and/or other shopping center where the media service provider has a kiosk set up to sell their other services. As such, a parent/guardian may use the service provider mobile terminal to remotely access their own customer premises media controller and/or a service provider media controller to thereby control presentation of media content at the customer premises. In addition, the parent/guardian could check on what is currently being viewed at the customer premises via the mobile terminal 125.

FIG. 3B is a block diagram further illustrating a mobile terminal configured to provide parental control over access to media content according to some embodiments of the present invention. As shown in FIG. 3B, a parental control application may be accessed and viewed on the mobile terminal 125 via the display 210. For example, the parental control application may be stored in the memory 230 of the mobile terminal 125. The parental control application is configured to present current parental control information 305 for one or more media controllers (received, for example, from the one or more media controllers via the transceiver 225) on the display 210. More particularly, as shown in FIG. 3B, the parental control application presents current parental control information 305 for Media Controller 1, which may be a digital cable box coupled to a television in a living room of a customer premises. Current parental control information for other media controllers, such as Media Controllers 2 and 3, may also be viewed on the display 210 by selecting the corresponding tabs 310. For example, Media Controller 2 may be a digital video recorder (DVR), such as a TiVo™ device, coupled to a television in a parent's bedroom, while Media Controller 3 may be coupled to a video gaming system, such as an XBox™, in a child's bedroom. Although illustrated with reference to three media controllers, parental control information for fewer or more media controllers may be presented at the mobile terminal 125 using the parental control application.

Still referring to FIG. 3B, the current parental control information 305 for Media Controller 1 includes preview/summary information 315, rating information 320, and permissions information 330 for six time-scheduled broadcast television programs 335 (Smallville, Seinfeld, Friends, Everwood, Desperate Housewives, and Sex and the City). Based on the current permissions information 330, Media Controller 1 is configured to allow presentation of Smallville, Seinfeld, Friends, and Everwood on Thursday, November 17, but is configured to prevent presentation of Desperate Housewives and Sex and the City. Information for each listed program may be accessed by scrolling through the list and selecting a particular program, for example, using the navigation keys 280 and/or the keypad 205. As such, a parent/guardian may view the preview/summary information 315 for a particular program on the display 210, and may adjust the permissions information 330 accordingly.

For example, a parent/guardian who wishes to adjust the parental control information for Smallville on Thursday, November 17, may select the corresponding program entry 335 via the navigation keys 280. If the parent/guardian wishes to view a preview of the selected entry 335, a media content preview request may be transmitted from the mobile terminal 125 to Media Controller 1 over a wide-area network responsive to the selecting the preview/summary information 315, and preview data may be received from Media Controller 1 and displayed on the display 210. The preview data may indicate that the episode of Smallville scheduled for Thursday, November 17 contains violence and sexual content that may be inappropriate for children.

The parent/guardian may also change the permissions information 330 for Smallville to “PROHIBITED” using the navigation keys 280. In response, a parental control request including updated parental control information may be transmitted from the mobile terminal 125 to Media Controller 1. As such, Media Controller 1 may thereby be configured to prevent presentation of the previously allowable episode of Smallville on Thursday, November 17, based on the updated permissions information. It is to be understood that, although illustrated with reference to time-scheduled broadcast programs on a particular date, the permissions information 330 may be set to enable or prevent presentation based on a particular time-scheduled broadcast series, time of day, channel, purchasable media content, and/or other parameter by which a parent/guardian may wish to control access to media content.

Although FIGS. 3A and 3B illustrate exemplary mobile terminals that may be used to provide parental control over access to media content, it will be understood that the present invention is not limited to such configuration, but is intended to encompass any configuration capable of carrying out the operations described herein. For example, although the memory 230 and the controller 240 are illustrated as separate components, the memory 230 or portions thereof may be included as part of the controller 240. More generally, while particular functionalities are shown in particular blocks by way of illustration, functionalities of different blocks and/or portions thereof may be combined, divided and/or eliminated.

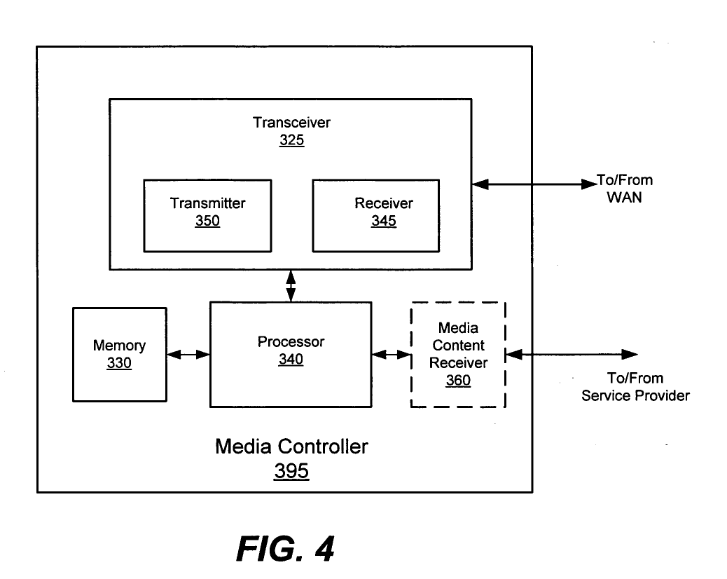

FIG. 4 is a block diagram illustrating a media controller 395 according to some embodiments of the present invention. In some embodiments, the media controller 395 may correspond to the customer premises media controller 115 of FIG. 1 and/or the service provider media controller 130 of FIG. 2. Referring now to FIG. 4, the media controller 395 includes a processor 340 coupled to a transceiver 325 (including a transmitter 350 and a receiver 345) and a memory 330. The processor 340 may be, for example, a commercially available or custom microprocessor that is configured to coordinate and manage operations of the transceiver 325 and the memory 330. The media controller 395 may be an IP addressable device coupled to a wide area network (WAN) via the transceiver 325, and as such, may be accessible via a packet-switched WAN connection. In addition, the media controller 395 may be coupled to a public-switched telephone network (PSTN), for access via a circuit-switched WAN connection. In some embodiments, the transceiver 325 may include a PLMN transceiver, similar to the transceiver 225 of the mobile terminal 125 of FIG. 3 as described above. Accordingly, the transceiver 325 may be configured to receive a parental control request from a mobile terminal, such as the mobile terminal 125 of FIG. 3, over a wide area network connection. Responsive to receiving the parental control request, the processor 340 may be configured to control presentation of media content.

For example, the media controller 395 may be a customer premises media controller, such as the customer premises media controller 115 of FIG. 1, located at a customer premises, such as the customer premises 105. As such, the media controller 395 may include a media content receiver 360 that is configured to receive media content from a media service provider, such as the media service provider 135. The media content may include time-scheduled broadcast media, such as television programs, interactive game content, and/or video on demand content, such as pay per view. The media controller 395 may be coupled to a TV/monitor, such as the TV/monitor 110 of FIG. 1, that is configured to present the media content. More specifically, responsive to receiving the parental control request at the transceiver 325, the processor 340 may be configured to present previously prohibited media content and/or prevent presentation of previously allowable media content via the television/monitor based on the parental control request. For example, the parental control request may include permissions information regarding previously prohibited and/or previously allowable media content, and the processor may be configured to enable or prevent presentation of the media content based on the permissions information contained in the parental control request. For instance, the processor 340 may be configured to control the transceiver 325 to refuse reception of previously allowable media content from the media service provider based on the parental control request. In addition, the media controller 395 may include a user interface configured to receive a local request for previously prohibited media content. Upon receipt of such a local request, the processor 340 may be configured to control the transceiver 325 to transmit a request for authorization to grant the local request to a mobile terminal over the wide area network connection. As such, a parent/guardian using the mobile terminal may be alerted when a child/dependent attempts to access previously prohibited media content.

Alternatively, the media controller 395 may be a service provider media controller, such as the service provider media controller 130 of FIG. 2. As such, the processor 340 may be configured to receive a plurality of parental control requests from a plurality of mobile terminals, and may identify a respective customer premises media controller for each received parental control request in order to control presentation of the media content. The processor 340 may identify a customer premises media controller corresponding to a received parental control request based on customer database information stored, for example, in the memory 330. In some embodiments, the processor 340 may control presentation of the media content at the identified customer premises media controller merely by providing a connection between the mobile terminal transmitting the parental control request and the identified customer premises media controller. However, the processor 340 may also be configured to transmit a control signal to the identified customer premises media controller. The control signal may be configured to enable or prevent presentation of the media content by the customer premises media controller.

In addition, the processor 340 may be configured to control transmission of media content to the identified customer premises media controller based on the parental control request. More specifically, the processor 340 may be configured to transmit previously prohibited media content and/or prevent transmission of previously allowable media content to the identified customer premises media controller based on permissions information contained in the parental control request. The media controller 395 may also store current parental control information for a plurality of customer premises media controllers, for example, in the memory 330, and may transmit current parental control information for a particular customer premises media controller to a requesting mobile associated therewith via the transceiver 325. The transceiver 325 may also be configured to transmit preview data associated with specified media content to a mobile terminal over the wide area network connection responsive to receiving a media content preview request from the mobile terminal.

Accordingly, the functionality of the media controller 395 may depend on the particular configuration of the system for providing parental control over access to media content according to some embodiments of the present invention. As such, although FIG. 4 illustrates an exemplary media controller that may be used to provide parental control over access to media content, it will be understood that the present invention is not limited to such a configuration but is intended to encompass any configuration capable of carrying out the operations described herein. For example, although illustrated in FIG. 4 as separate components, the functionality of the transceiver 325 and the media content receiver 360 may be included in a single component.

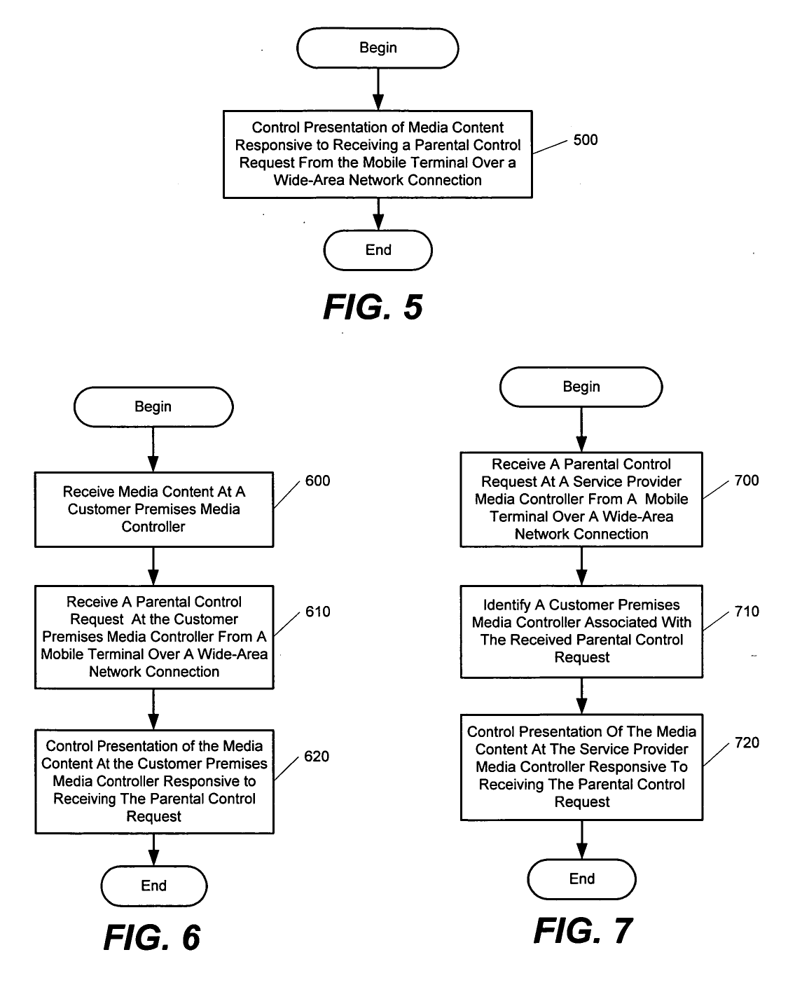

Exemplary operations for providing parental control over access to media content according to some embodiment of the present invention will now be described with reference to the flowcharts of FIGS. 5 to 10. FIGS. 5 to 8 illustrate exemplary operations that may be performed by a media controller, such as the media controller 395 of FIG. 4. Referring now to FIG. 5, presentation of media content is controlled responsive to receiving a parental control request from a mobile terminal over a wide area network connection at block 500. For example, presentation of the media content may be controlled by a customer premises media controller, such as the customer premises media controller 115 of FIG. 1, and/or a service provider media controller, such as the service provider media control 130 of FIG. 2. The parental control request may include updated parental control information, such as permissions information, for particular media content.

FIG. 6 is a flowchart illustrating operations that may be performed by a customer premises media controller, such as the customer premises media controller 115 of FIG. 1, according to some embodiments of the present invention. Referring now to FIG. 6, operations begin at block 600 when media content is received at a customer premises media controller. For example, the media content may be received at the customer premises media controller from a media service provider, such as the media service provider 135 of FIG. 1, via a cable, satellite, and/or broadcast connection thereto. At block 610, a parental control request is received at the customer premises media controller from a mobile terminal over a wide area network connection. Responsive to receiving the parental control request from the mobile terminal, presentation of the media content is controlled at the customer premises media controller at block 620. For example, presentation of the media content may be enabled or prevented based on the received parental control request.

FIG. 7 is a flowchart illustrating operations that may be performed by a service provider media controller, such as the service provider media controller 130 of FIG. 2, according to some embodiments of the present invention. Referring now to FIG. 7, a parental control request is received at a service provider media controller from a mobile terminal over a wide area network connection at block 700. At block 710, a customer premises media controller associated with the parental control request is identified by the service provider media controller. Presentation of the media content at the identified customer premises media controller is controlled by the service provider media controller at block 720 responsive to receiving the parental control request. For example, presentation of the media content may be controlled by transmitting a control signal from the controller to the identified customer premises media controller, by preventing and/or enabling transmission of media content to the identified customer premises media controller by the service provider media controller, and/or by simply providing a connection to the identified customer premises media controller.

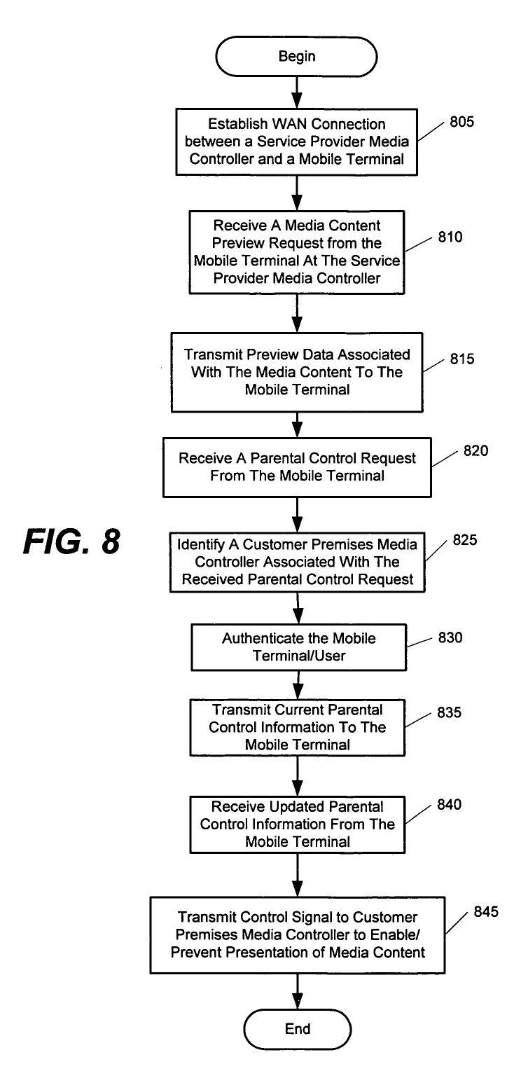

Further operations for providing parental control over access to media content which may be performed by a service provider media controller will be described with reference to the embodiments of FIG. 8. As shown in FIG. 8, operations begin when a wide area network (WAN) connection between a service provider media controller and a mobile terminal is established at block 805. A media content preview request is received from the mobile terminal at the service provider media controller at block 810. Responsive to the preview request, preview data associated with the media content specified in the preview request is transmitted from the service provider media controller to the mobile terminal at block 815. A parental control request is received from the mobile terminal at block 820, and a customer premises media controller associated with the received parental control request is identified at block 825, for example, based on identification information included in the parental control request. Based on this identification, the mobile terminal and/or the user thereof is authenticated by the service provider media controller at block 830. For example, authentication may be performed using public and/or private key cryptography, as is well known in the art. Upon successful authentication, current parental control information is transmitted from the service provider media controller to the mobile terminal at block 835, and updated parental control information is received at the service provider media controller from the mobile terminal at block 840. For example, if the specified media content is deemed appropriate based on the preview data, the updated parental control information may include a change in the permissions information associated with the specified media content. Based on the updated parental control information, a control signal is transmitted from the service provider media controller to the customer premises media controller to enable or prevent presentation of the media content at block 845. Accordingly, a remote override of the current parental control information for the media content may be achieved.

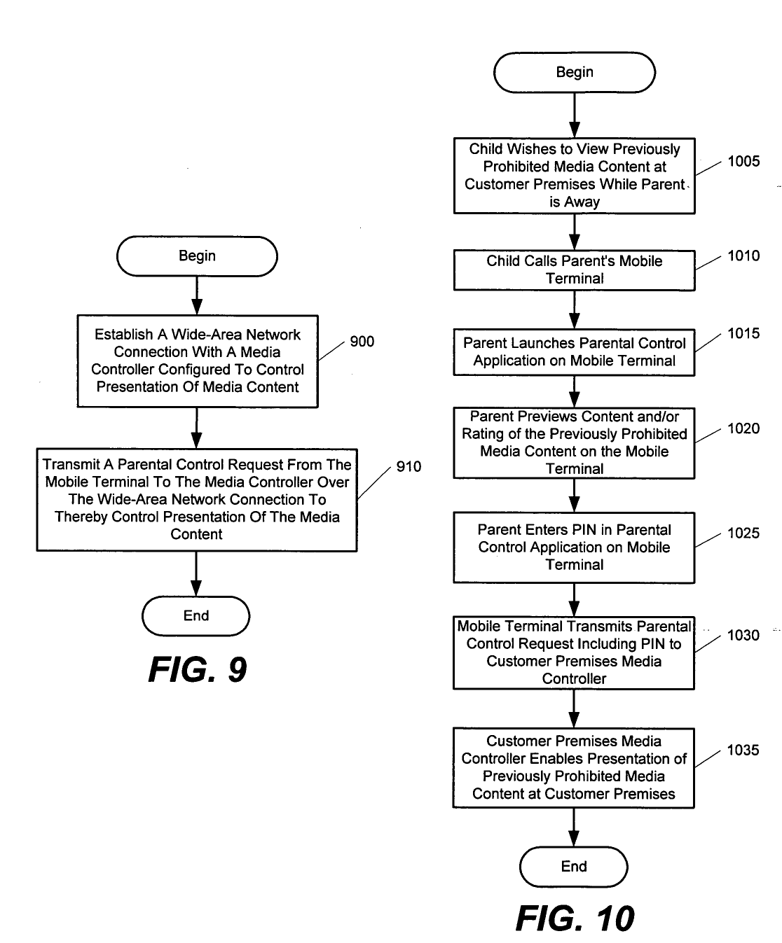

FIG. 9 is a flowchart illustrating operations that may be performed by a mobile terminal that is configured to provide parental control over access to media content according to some embodiments of the present invention. Referring now to FIG. 9, a wide area network connection is established between a mobile terminal and a media controller that is configured to control presentation of media content at block 900. As discussed above, the media controller may be a customer premises media controller and/or a service provider media controller. The location of the media controller may be transparent to the mobile terminal. At block 910, a parental control request is transmitted from the mobile terminal to the media controller over the wide area network connection. The media controller may be configured to enable and/or prevent presentation of media content specified in the parental control request responsive to receiving the request, as discussed above. As such, presentation of the media content may be remotely controlled using a mobile terminal.

FIG. 10 is a flowchart illustrating operations for providing parental control over access to media content according to further embodiments of the present invention. As shown in FIG. 10, operations begin at block 1005, when a child wishes to watch a previously prohibited movie and/or program while the parent and/or guardian of the child is away. At block 1010, the child calls the parent/guardian's mobile terminal and requests that the parent/guardian provide the child with access to the previously prohibited movie/program. In response to the request, the parent/guardian launches a parental control application on the mobile terminal at block 1015. Using the parental control application, the parent/guardian views the content, rating, and/or other preview information associated with the movie/program, as specified by the child, at block 1020. Then, after agreeing that the specified movie/program is appropriate for the child/dependent, the parent/guardian enters his personal PIN into the parental control application of the mobile terminal at block 1025. The PIN is transmitted from the mobile terminal to a cable box and/or other customer premises media controller at block 1030, and presentation of the previously prohibited movie/program is enabled at the customer premises by the customer premises media controller at block 1035. Although described above primarily with reference to movies/programs, it is to be understood that the present invention may also be used to control access to other types of media content that may be inappropriate for children, such as video games.

As will be appreciated by one of skill in the art, the present invention may be embodied as a method, system, device, and/or computer program product. Accordingly, the present invention may take the form of an entirely hardware embodiment, a software embodiment or an embodiment combining software and hardware aspects all generally referred to herein as a “circuit” or “module”. Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the customer premises media controller, partly on the customer premises media controller, as a stand-alone software package, partly on the customer premises media controller and partly on a service provider media controller, or entirely on the service provider media controller. In the latter scenario, the service provider media controller may be connected to the customer premises media controller through a local area network (LAN) or a wide area network (WAN), or the connection may be made to an external computer (for example, through the Internet using an Internet Service Provider). In some embodiments, the program code may also execute either partly or entirely on a mobile terminal.

Furthermore, the present invention was described in part above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and schematic diagrams of FIGS. 1-10 illustrate the architecture, functionality, and operations of some embodiments of methods, devices, systems, and computer program products for providing parental control over access to media content. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed:

1. A method for providing parental control over access to media content, the method comprising:
controlling presentation of the media content responsive to receiving a parental control request from a mobile terminal over a wide-area network connection.

2. The method of claim 1, further comprising:
receiving available media content at a customer premises media controller; and
receiving the parental control request at the customer premises media controller over the wide-area network;
wherein controlling presentation comprises controlling presentation of the available media content at the customer premises media controller responsive to the received parental control request.

3. The method of claim 2, wherein the parental control request comprises permissions information for previously prohibited media content, and wherein controlling presentation of the media content at the customer premises media controller comprises:
presenting the previously prohibited media content via a television/monitor coupled to the customer premises media controller based on the permissions information.

4. The method of claim 3, further comprising the following prior to presenting the previously prohibited media content:
receiving a local request at the customer premises media controller for the previously prohibited media content; and
transmitting a request for authorization to grant the local request from the customer premises media controller to the mobile terminal over the wide-area network connection.

5. The method of claim 2, wherein the parental control request comprises permissions information for previously allowable media content, and wherein controlling presentation of the media content at the customer premises media controller comprises:
limiting presentation of the previously allowable media content on a television/monitor coupled to the customer premises media controller based on the permissions information.

6. The method of claim 5, wherein limiting presentation of the previously allowable media content further comprises:
preventing reception of the previously allowable media content at the customer premises media controller.

7. The method of claim 2, wherein receiving the parental control request comprises:
receiving the parental control request at the customer premises media controller via a local network hub coupled thereto.

8. The method of claim 2, wherein receiving the parental control request comprises:
receiving the parental control request at the customer premises media controller from a remotely-located mobile terminal.

9. A computer program product for providing parental-controlled access to media content, the computer program product comprising a computer readable storage medium having computer readable program code embodied therein configured to carry out the method of claim 2.

10. The method of claim 1, further comprising:
receiving the parental control request at a service provider media controller over the wide-area network connection; and
identifying a customer premises media controller associated with the received parental control request;
wherein controlling presentation of the media content comprises controlling presentation of the media content at the service provider media controller responsive to the received parental control request.

11. The method of claim 10, wherein controlling presentation of the media content at the service provider media controller comprises:
providing the mobile terminal with access to the identified customer premises media controller over the wide-area network.

12. The method of claim 10, wherein controlling presentation of the media content at the service provider media controller comprises:
transmitting a control signal from the service provider media controller to the customer premises media controller responsive to the received parental control request.

13. The method of claim 10, wherein the parental control request comprises permissions information for previously prohibited media content, and wherein controlling presentation of the media content at the service provider media controller comprises:
transmitting the previously prohibited media content to the customer premises media controller based on the permissions information.

14. The method of claim 10, wherein the parental control request comprises permissions information for previously allowable media content, and wherein controlling presentation of the media content at the service provider media controller comprises:
preventing transmission of the previously allowable media content to the customer premises media controller based on the permissions information.

15. A computer program product for providing parental-controlled access to media content, the computer program product comprising a computer readable storage medium having computer readable program code embodied therein configured to carry out the method of claim 10.

16. The method of claim 1, further comprising:
receiving a media content preview request from the mobile terminal over the wide-area network connection; and
transmitting preview data associated with the media content to the mobile terminal over the wide-area network connection responsive to the received preview request;
wherein the parental control request is received responsive to transmitting the preview data to the mobile terminal.

17. The method of claim 1, wherein the media content comprises time-scheduled broadcast media content, interactive game content, and/or video-on-demand content.

18. The method of claim 1, further comprising:
authenticating the received parental control request,
wherein controlling presentation of the media content further comprises controlling presentation of the media content responsive to authenticating the parental control request.

19. The method of claim 1, wherein controlling presentation of the media content comprises:
requesting a passcode from the mobile terminal responsive to the received parental control request;
receiving the passcode from the mobile terminal over the wide-area network connection;
comparing the received passcode to a predetermined authorization code; and
controlling presentation of the media content when the received passcode corresponds to the predetermined authorization code.

20. The method of claim 1, further comprising:
transmitting current parental control information to the mobile terminal over the wide-area network connection responsive to the received parental control request; and
receiving updated parental control information from the mobile terminal over the wide-area network connection;
wherein controlling presentation of the media content comprises controlling presentation of the media content based on the updated parental control information.

21. The method of claim 1, further comprising:
transmitting the parental control request over the wide-area network connection;
wherein the parental control request identifies particular media content and includes permissions information associated with the particular media content.

22. A method of operating a mobile terminal to provide parental control over access to media content, the method comprising:
establishing a wide-area network connection with a media controller configured to control presentation of the media content; and
transmitting a parental control request from the mobile terminal to the media controller over the wide-area network connection;
wherein the parental control request is configured to control presentation of the media content.

23. The method of claim 22, further comprising:
receiving current parental control information from the media controller over the wide-area network connection responsive to transmitting the parental control request thereto; and
transmitting updated parental control information to the media controller over the wide-area network connection.

24. The method of claim 23, wherein transmitting the updated parental control information comprises:
transmitting an authorization to present previously prohibited media content and/or to prevent presentation of previously allowable media content to the media controller over the wide-area network connection.

25. The method of claim 22, wherein transmitting the parental control request comprises:
transmitting the parental control request over the wide-area network connection to a customer premises media controller coupled to a television/monitor configured to present the media content.

26. The method of claim 22, wherein transmitting the parental control request comprises:
transmitting the parental control request to a service provider media controller over the wide-area network connection.

27. The method of claim 22, further comprising:
transmitting a media content preview request to the media controller over the wide-area network connection; and
receiving preview data associated with the media content from the media controller over the wide-area network connection responsive to transmitting the media content preview request;
wherein transmitting the parental control request comprises transmitting the parental control request responsive to the received preview data.

28. A mobile terminal configured to carry out the method of claim 22.

29. A computer program product for providing parental control over access to media content, the computer program product comprising a computer readable storage medium having computer readable program code embodied therein configured to carry out the method of claim 22.

30. A media controller, comprising:
a receiver configured to receive a parental control request from a mobile terminal over a wide-area network connection; and
a processor coupled to the receiver and configured to control presentation of the media content responsive to the received parental control request.

31. The media controller of claim 30, further comprising:
a media content receiver configured to receive media content from a media service provider.

32. The media controller of claim 31, wherein the processor is configured to present previously prohibited media content and/or prevent presentation of previously allowable media content via a television/monitor coupled thereto based on the parental control request.

33. The media controller of claim 32, wherein the processor is configured to control the media content receiver to prevent reception of the previously allowable media content from the media service provider based on the parental control request.

34. The media controller of claim 30, wherein the processor is configured to identify a customer premises media controller associated with the received parental control request and control presentation of the media content thereto.

35. The media controller of claim 34, wherein the processor is configured to transmit a control signal to the customer premises media controller to control presentation of the media content thereby.

36. The media controller of claim 34, wherein the processor is configured to transmit previously prohibited media content and/or prevent transmission of previously allowable media content to the customer premises media controller based on the parental control request.

37. The media controller of claim 30, wherein the receiver is configured to receive a media content preview request from the mobile terminal, and further comprising:
a transmitter configured to transmit preview data associated with the media content to the mobile terminal over the wide-area network connection.
